(19) United States
(12) Patent Application Publication
(10) Pub. No.: US 2005/0248631 A1
(43) Pub. Date: Nov. 10, 2005

(54) Stitched printing system

(76) Inventors: Adam I. Pinard, Carlisle, MA (US); Roland Guilmet, Pepperell, MA (US)

Correspondence Address: Kristofer E. Elbing, 187 Pelham Island Road, Wayland, PA, 01778, US

(21) Appl. No.: 10/842,196

(22) Filed: May 10, 2004

(51) Int. Cl. B41J 2/07

(52) U.S. Cl. 347/74

(57) ABSTRACT

Disclosed is a continuous ink jet printing apparatus and related method. The method can feature deflecting a first stream of ink drops to create a first deposition pattern, and deflecting a second stream of ink drops to create a second deposition pattern that overlaps at least in part with the first deposition pattern. Print density can be adjusted for drops corresponding to a region of overlap between the first and second deposition patterns.

### CROSS-REFERENCE TO RELATED APPLICATION

This application is related to an application entitled JET PRINTER WITH ENHANCED PRINT DROP DELIVERY, filed on the same day as this application under Ser. No. ______ which is herein incorporated by reference.

### FIELD OF THE INVENTION

This invention relates to jet printers, including color printers and jet printers for direct-to-plate printing.

### BACKGROUND OF THE INVENTION

Inkjet printers operate by charging drops of ink with a charging electrode and guiding them to a print substrate through a high intensity electric field. Printers can modulate the charge on an ink drop by changing the charging electrode voltage to select whether each drop is to be printed or instead sent to a gutter. Printers may also adjust the charging voltage to compensate for aerodynamic effects and for the influence of the charge from adjacent drops. Some printers employ a technique known as “swathing” to continuously change the field and thereby direct drops from one or more stationary ink jets to different locations on the printing substrate, instead of moving a print head across the substrate.

Jet printing techniques are applicable to direct-to-plate printers. Such printers typically apply a printing fluid to a sheet of plate stock mounted on a drum. This fluid causes changes in the portions of the surface of the plate on which it is deposited. Although further processing of the plate may be necessary, the result is a printing plate that can serve to print large numbers of pages.

### SUMMARY OF THE INVENTION

In one general aspect, the invention features a continuous ink jet printer that includes a deflection element located proximate an output trajectory of an ink jet printing nozzle and operative to deflect the ink drops in a first pattern as they are deposited on a substrate. A second deflection element is located proximate an output trajectory of a second nozzle and operative to deflect the ink drops in a second pattern as they are deposited on the substrate, with the first and second patterns overlapping at least partially. Also provided is stitching logic that includes density adjustment logic operative to adjust print density for the jet printing nozzles in a region of the substrate that is within both of the patterns.

In preferred embodiments, the stitching logic can be operative to define a pair of complementary linear density progressions. The stitching logic can include stochastic screening logic to randomize printing in the region of the substrate that is within the first and second patterns. The print substrate can be a printing plate. The print substrate can be a plastic bottle. The deflection element can be one of a pair of deflection electrodes. The printer can further include swathing logic to generate the first and second patterns as swathed patterns. The swathing logic can include a series of different firing order entries that define different deflection amounts for at least one of the deflection elements. The printer can further include binary logic to generate the first and second patterns as binary patterns. The printer can further include halftone screening logic and wherein the first and second ink jet printing nozzles are responsive to the halftone screening logic. The printer can further include interleaving logic operative to cause the first and second ink jet printing nozzles to print simultaneously. The interleaving logic can further include self interleaving logic operative to cause at least one of the first and second ink jet printing nozzles to print in a series of self-interleaved passes. The stitching logic can be operative to cause the first and second ink jet printing nozzles to print drops in the region during a same pass. The stitching logic can be operative to cause the first and second ink jet printing nozzles to print drops in the region during a different pass. The printer can further include a substrate feed mechanism to feed the substrate. The substrate feed mechanism can include a drum. The nozzles can be in a series of nozzles spaced along a direction of rotation of the substrate. The feed mechanism can include a platen. The substrate feed mechanism can be operative to cause printing to take place in a helical scan. The substrate feed mechanism can be operative to cause printing to take place in a single pass between a) the substrate and b) the first and second nozzles. The substrate feed mechanism can be operative to cause printing to take place in a multiple passes between a) the substrate and b) the first and second nozzles. The first and second ink jet printing nozzles can be both positioned to print at pixel positions on a same grid having horizontal and vertical pitches equal to those of the first and second nozzles.

In another general aspect, the invention features a continuous ink jet printing method that includes deflecting a first stream of ink drops to create a first deposition pattern, and deflecting a second stream of ink drops to create a second deposition pattern that overlaps at least in part with the first deposition pattern. Print density is adjusted for drops corresponding to a region of overlap between the first and second deposition patterns. In preferred embodiments, the steps of deflecting can deflect swathed deposition patterns.

In a further general aspect, the invention features a continuous ink jet printer that includes means for firing a first stream of ink drops, means for deflecting drops in the first stream to create a first deposition pattern, means for firing a second stream of ink drops, means for deflecting drops in the second stream to create a second deposition pattern that overlaps at least in part with the first deposition pattern, and means for adjusting print density for drops corresponding to a region of overlap between the first and second deposition patterns. In preferred embodiments, the means for deflecting can deflect swathed deposition patterns.

Systems according to the invention can reliably stitch together different swath-printed regions being printed in by different nozzles. The result is a larger region that can appear quite uniform, even if there is some level of registration error between the nozzles or if there is some difference in darkness, such as may result from differences in ink drying time. Printing a larger area with multiple nozzles in this way can allow systems according to the invention to print on a substrate much more quickly. And tolerance of some level of registration error can allow a less precisely aligned, and therefore less expensive, printer to perform the printing.

### BRIEF DESCRIPTION OF THE DRAWINGS

FIG. 1 is a system-level block diagram illustrating elements of a jet printer according to the invention;

FIG. 2 is a flow chart illustrating the operation of the printer of FIG. 1;

FIG. 3 is an interleaving diagram for a two-nozzle interleaving and three-channel swathing printer;

FIG. 4 is a combined block diagram and ink deposition density chart illustrating stitching operations for the printer of FIG. 1; and

FIG. 5 is a combined block diagram and ink deposition density chart illustrating stitching operations for a variant of the printer of FIG. 1.

### DETAILED DESCRIPTION OF AN ILLUSTRATIVE EMBODIMENT

A jet printer 10 according to the invention includes a print substrate feed mechanism 12, a print head assembly 14, and a control circuit 16. The feed mechanism includes a print drum 30, which supports a print substrate 32, such as a piece of paper print stock or a printing plate. A motor 34 drives the drum 30 via a coupling mechanism 36. The printer is also equipped with stitching logic 80, as will be discussed in more detail below.

The print head assembly 14 includes a print head that includes one or more nozzle assemblies 20 . . . 20 N each having a charging electrode 22 . . . 22N, such as a charging tunnel, at its output. A pair of deflection electrodes (e.g., 24, 26) is located on opposite sides of the path that a drop takes when exiting the nozzle. The deflection electrodes, the charging tunnel, and the nozzle assembly can all be mounted on a carriage 29 driven by a carriage actuator 28. The carriage actuator is operative to move the carriage along a path that is parallel to the axis of rotation of the drum.

The control circuit 16 includes a print control processor 40 that can include interleaving logic 41 and has a control output provided to a drum control interface 42. The print control processor also has a data port operatively connected to a data port of a storage element 44, and a data port operatively connected to a digital filter 46. The digital filter has an output provided to a digital input of a digital-to-analog converter 48, which has an analog output provided to an input of a high-voltage amplifier 50. The amplifier has an output that is operatively connected to the charging electrode 22. Also provided is a high-voltage source 27 that can be controlled by the print control processor 40 and that has an output operatively connected to one of the deflection electrodes 26. The other deflection electrode 24 can be operatively connected to a fixed voltage source, such as ground.

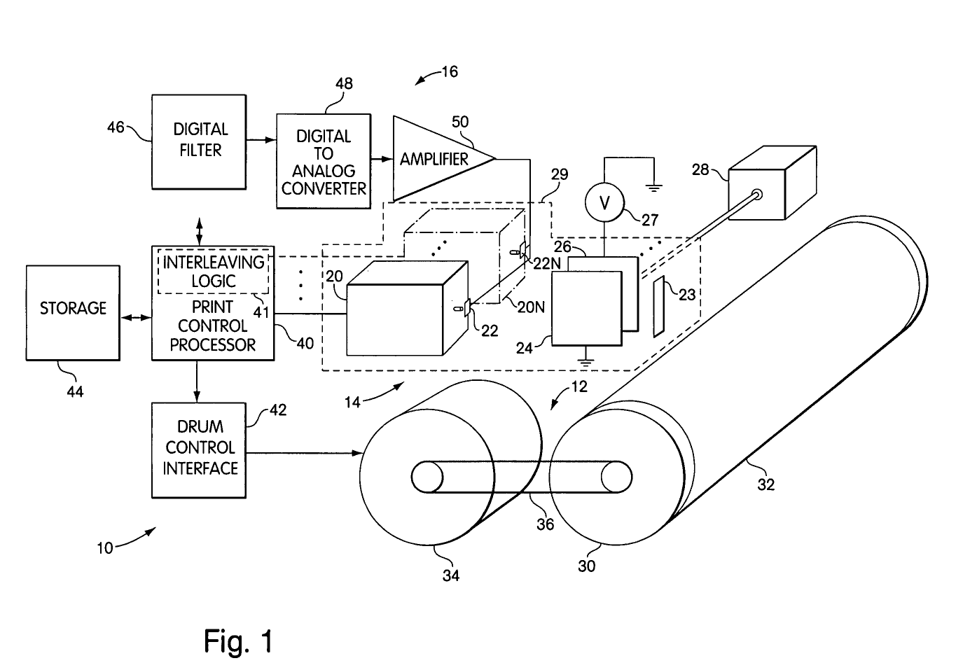

FIG. 1 is intended as a general illustration of a printer according to the invention, and one of skill in the art would be able to modify its design in a number of ways while still obtaining benefits from the invention for different applications. For example, a number of different mechanisms can be used for the carriage actuator such as toothed-belt or lead-screw mechanisms. And while a drum-based feed mechanism 12 is appropriate for printing directly on lithographic plates, other printing applications may employ different kinds of mechanisms, such as continuous feed paper on a platten.

Features and functionality of the various circuit elements shown in FIG. 1 can also be combined in different ways. For example, the print control processor 40 can incorporate control routines that control the motor 34, allowing a signal from the print control processor or a simple buffered version of that signal to drive the motor. This eliminates the need for a dedicated hardware drum control circuit 42, which receives only a simple on/off signal from the print control processor. The print control processor can be located inside the printer, or it can be located remote from the printer and communicate with the printer, such as via serial cable.

Note that it is also possible to apply the invention to different types of deflection configurations by modulating the excitation provided to one or more of its deflection elements. For example, it is possible to modulate the voltage on the deflection electrodes 24, 26 instead of, or in addition to, modulating the voltage on the charging electrode 22. In addition, it is also possible to operate a jet printer without a charging electrode and modulate only a voltage on one or more deflection electrodes. It is even possible to modulate other approaches to guiding a drop, such as by modulating a magnetic field instead of an electric field.

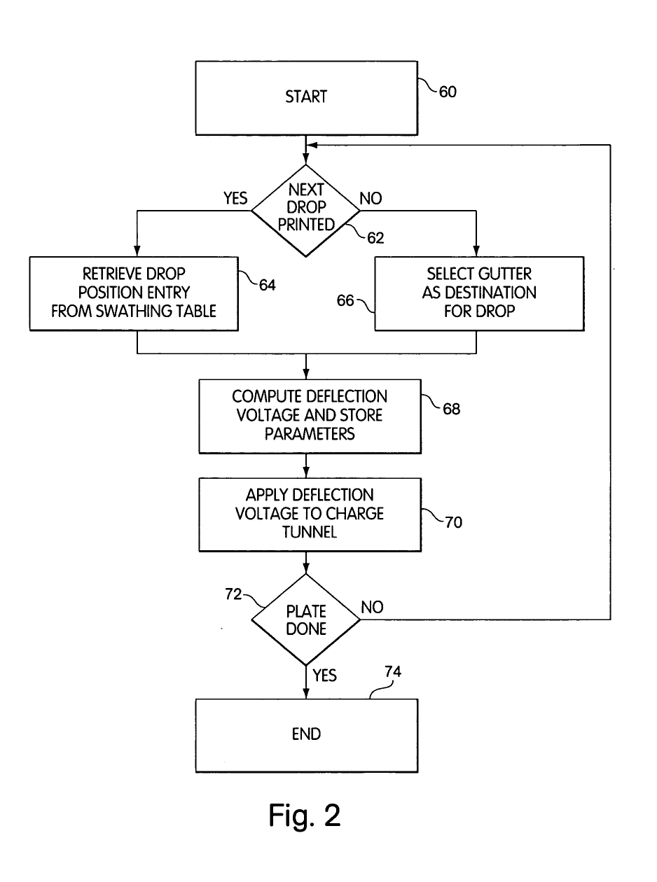

In operation, referring to FIGS. 1 and 2, operation of the jet printer 10 begins with operator set-up of the printer and a software start command (step 60). In the case of a direct-to-plate printer that prints on aluminum or plastic plates, an operator first mounts a fresh plate 32 on the printer's drum 30. The operator then causes a host system to download data representing the material to be printed into the print control processor 40. The print control processor can also download coefficients into the digital filter 46, or run a calibration routine to derive these coefficients, if these are not stored locally. Calibration can be performed by depositing printing fluid drops on a calibration needle and adjusting the filter coefficients until an optimal transfer function has been reached. The processor can then instruct the drum control interface 42 to start the motor 34, which causes the drum 30 to rotate.

After the drum is up to speed, the print control processor 40 instructs the nozzle assembly 20 to generate a series of charged printing fluid drops, which pass through the charging electrode 22 and then between the deflection electrodes 24, 26. The magnitude of the voltage to be applied to the charging electrode 22 by the amplifier 50 depends on whether and where each particular drop is to be printed (step 62). If a drop is not to be printed, such as in the case of a guard drop, the print control processor 40 will select a gutter or knife edge 23 as the destination for the drop (step 66). The print control processor will then compute an appropriate voltage to be applied to the charging electrode given the voltage between the deflection electrodes, to guide the drop into the gutter (step 68). Typically, this voltage is either the maximum or minimum voltage that the amplifier is configured to provide.

If the drop is to be printed, the print control processor 40 retrieves a drop position entry from a swathing table, which can be stored in the storage 44 (step 64). The entries in the swathing table are designed to cause successive, but non-adjacently deposited, drops to be separated from each other on the plate radially due to rotation of the drum and longitudinally due to the swathing. Because the drops are spaced in this way in these two polar dimensions, they will not touch each other. This is particularly important in half-tone printing, where only single, separate drops are deposited. Of course, the order in which the print data is sent to the print head must take the swathing sequence into consideration.

Superimposed on the swathing voltage is a voltage derived by the digital filter 46, which compensates for aerodynamic effects and for the influence of the charge on adjacent drops. The digital filter can be an Infinite-Impulse-Response (IIR) filter implemented using a digital signal processor, such as the TMS 320C203 integrated circuit available from Texas Instruments. The filter function implemented is:
OUT(n)=B0*IN(n)+B1*IN(n−1)+B2*IN(n−3)+A1*OUT(n−1)+A2*OUT(n−2)

Coefficients used in the function for one embodiment are:

TABLE I
IIR Coefficients

| | |
|---|---|
| b0 | 0.05 |
| b1 | 0.67 |
| b2 | −0.32 |
| a1 | 0.6 |
| a2 | 0 |

Where IN(n) represents the desired position of drop number n, and OUT(n) represents the electrode voltage for drop number n resulting from the application of the filter. In a system that has sufficient computational capacity, it is contemplated that further coefficients could be included in this function. Digital filter design is discussed in, for example, “Digital Signal Processing,” Chapter 5, Alan VanOppenheim and Ronald W. Schafer, Prentice-Hall Inc. (1975), which is herein incorporated by reference.

Table 2 illustrates the operation of the digital filter for the initial drops to be printed in a print job. As can be seen from this table, charge interaction between drops and aerodynamic effects cause the filter voltage required to place the drop at a desired position to change from drop to drop.

TABLE 2

| | Normalized | Normalized |
|---|---|---|
| | Desired Drop | Charging |
| Drop Number | Position | Voltage |
| 0 | 1 | 0.050 |
| 1 | 1 | 0.750 |
| 2 | 1 | 0.850 |
| 3 | 1 | 0.910 |
| 4 | 1 | 0.946 |
| 5 | 1 | 0.968 |
| 6 | 1 | 0.981 |
| 7 | 1 | 0.988 |
| 8 | 0 | 0.943 |
| 9 | 0 | 0.246 |
| 10 | 0 | 0.147 |
| 11 | 0 | 0.088 |
| 12 | 0 | 0.053 |
| 13 | 0 | 0.032 |
| 14 | 0 | 0.019 |
| 15 | 0 | 0.011 |
| 16 | 0 | 0.007 |

Once the charging voltage has been computed, the digital filter supplies a code corresponding to that voltage to the digital-to-analog converter 48. The digital-to-analog converter converts this code into an analog voltage, which it presents on its analog output. The amplifier 50 then amplifies the analog voltage to a high level, which is applied to the charging electrode 22 (step 70).

When a final drop has been sent (step 72), the printer can be powered down, or a new print operation can begin (step 74). If drops remain to be printed, the process of determining a charging electrode voltage begins again for the next drop (step 62).

In one particular embodiment, a printer employs a continuous jet head that has multiple jet assemblies and employs swathed bitmap capability to print up to 16 rasters per revolution per channel in a helical progression about the drum. This high resolution bitmap capability allows every drop to be used on halftone images without any of them merging.

It has been empirically determined that 1200 dots per inch (DPI) can be accomplished using a 10 um nozzle at jet velocity of 50 m/s printing a 16 pixel wide swath with a firing order of: 0, 8, 4, 12, 1, 9, 5, 13, 2, 10, 6, 14, 3, 11, 7, 15. This order is stored as a series of charge values in a 32-entry swathing table that also has an entry for non-printing drops, although other types of swathing tables can be used as well. The separation on the individual charges corresponds to a voltage of approximately 4 volts. This requires a total voltage swing of about 128 volts on the charging electrode. A nominal separation of 64 volts between printed and non-printed drops provides sufficient separation for the knife edge to operate properly.

The deflection voltage on the nozzle assemblies is programmable by software from 0 to 2200 Volts, and the deflection voltages for each nozzle assembly are to be sensed individually. Stimulation is common for all nozzle assemblies and is a square wave with an amplitude that can be controlled from 2.5 to 41 Volts. The charging voltage output has 1024 discrete levels between +35 and −115 Volts with a settling time of 125 ns.

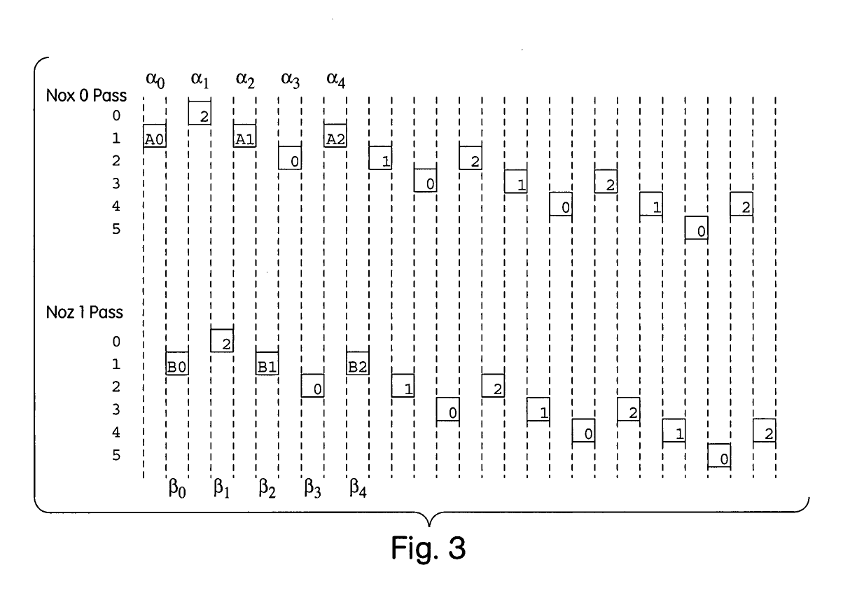

Referring to FIG. 3, it can be advantageous to combine interleaving and swathing in printers according to the invention. In such a system, a print head that includes a series of jets spaced along the direction of rotation of the drum simultaneously prints in parallel swathed helical progressions with offset rasters. This combination of swathing and interleaving allows for fast printing and a high degree of separation of the deposited ink drops.

An illustrative printing sequence is shown in FIG. 3 for a printer with two nozzles that and each employ three-channel swathing, and that are interleaved with each other and with themselves. In this example, a first nozzle deposits its ink drops at equally spaced intervals during a first revolution. During a second revolution, the first nozzle again deposits its ink drops at equally spaced intervals, but places them between the drops deposited during the first revolution.

At the same time, a second nozzle is also depositing its ink drops at equally spaced intervals, but these are offset from the positions used by the first channel, such that they fall in the gaps left by the first nozzle. The result is an interleaved printing sequence where adjacent drops from one jet are printed on different revolutions, and where these drops are also separated by adjacent drops from another jet.

In the illustrated horizontally interleaved print progression, a first jet deposits a first drop A0 in a first stripe ∀0. It then deposits a second drop A1 in a third stripe ∀2. Finally, it deposits a third drop A3 in a fifth stripe ∀4. This pattern begins again as the print head advances with respect to the substrate while printing in even-numbered stripes.

During the same pass of the print head, a second jet is depositing a second swath, at a different position along the direction of rotation of the drum. This second swath begins when the second jet deposits a first drop B0 in a first offset stripe ∃1. It then deposits a second drop B1 in a third offset stripe ∃2. Finally, it deposits a third drop B2 in a fifth offset stripe ∃4. This pattern begins again as the print head advances with respect to the substrate while printing in even-numbered offset stripes.

During the same pass of the next revolution, the first jet will fill in remaining gaps by depositing drops in the odd-numbered stripes (i.e., ∀1, ∀3, etc.). Similarly, the second jet will fill in remaining gaps by depositing drops in the odd-numbered offset stripes (i.e., ∃1, ∃3, etc.).

The illustrated print order employs horizontal interleaving to separate drops in the direction of the axis of rotation of the drum. This effect can also be accomplished in the direction of rotation of the drum by performing vertical interleaving, in which adjacent print lines are deposited on different passes or even different rotations of the drum. And both horizontal and vertical interleaving can be performed by just a single jet, by interleaving over multiple passes and/or rotations.

For the purpose of clear illustration, the example shown in FIG. 3 employs a left-to-right firing order. It is also advantageous to combine interleaving and jumbled swathing order, however, to achieve a high degree of spacing between drops, and to avoid the creation of Moiré patterns. In one embodiment, it is believed that satisfactory 2400 DPI printing can be accomplished using the interleaving presented in connection with FIG. 3 and a 15-drop swath width. The firing order for this embodiment is 1, 8, 4, 13, 0, 6, 10, 3, 14, 7, 11, 2, 9, 5, 12. By appropriate selection of the type of interleaving and the number of swathing and interleaving channels, printing speed and resolution can be optimized for the deposition characteristics of a particular print head, ink, and substrate combination. Preferably, the carriage and drum are advanced continuously to achieve a smooth and precise helical progression, allowing for high precision deposition of ink drops.

The interleaving can be implemented using interleaving logic that directs appropriate pixels to the interleaved jets. This logic can be implemented in a number of ways, including by the use of dedicated logic circuitry, look-up tables, or software running on a processor, such as a print control processor for a multi-source print head. The logic can be separate from the logic implementing the swathing table, or the two functions may be implemented with some overlap.

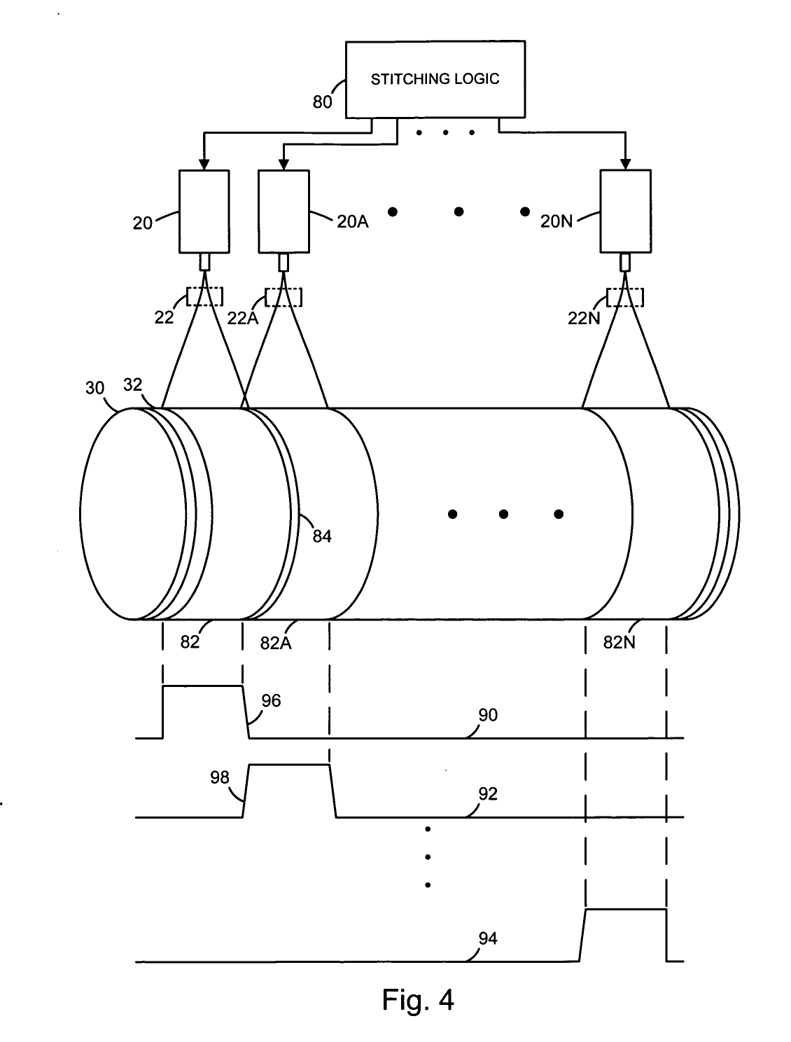

Referring to FIG. 4, embodiments with multiple nozzles can simultaneously deposit partially interleaved or “stitched” swaths. In such systems, adjacent nozzle assemblies (e.g., 20, 20A) and their deflection elements (e.g., 22, 22A) are positioned such that the swaths that they deposit on a substrate 32 overlap partially. This partial overlap can be distinguished from a full overlap, which may be used in connection with an interleaved printing technique. It should also be noted that in this embodiment, the adjacent nozzle assemblies are capable of printing on a same grid, which may not be the case for interleaved nozzles.

The adjacent nozzle assemblies (e.g., 20, 20A) are also responsive to stitching logic 80 that adjusts print density in overlap regions (e.g., 84) between adjacent regions (e.g., 82, 82A) deposited by the adjacent nozzles. The stitching logic can be part of a separate hardware or software entity, or it can be incorporated into other parts of the printer. It can implement density adjustments in any suitable way, such as by sending a selected subset of the print drops, which would otherwise be printed, to the gutter.

In operation, as a first nozzle assembly 20 deposits a first swath of ink onto a first region 82 of a substrate 32 mounted on a drum 30, the stitching logic reduces the density 90 of ink deposited in the part of the first swath that corresponds to an overlap region 84. At the same time, a second nozzle assembly 20A deposits a second swath of ink onto a second region 82A of the substrate, and the stitching logic reduces the density of ink 92 deposited in the part of the second swath that corresponds to the overlap region 84. The reduction in density can take place as a pair of complementary linear progressions, in which the ink density from the first nozzle decreases linearly 96 while the ink density from the second nozzle increases linearly 98 in such a way that the total ink density deposited in the overlap region 84 remains constant. Other density progressions are of course also possible, with some degree of randomness or dithering being preferable to reduce artifacts. These artifacts can be reduced by using a tile for which a cross-correlation between pixels in the two regions falls off toward zero as quickly as possible as the areas are shifted with respect to each other. The optimal solution to this problem will depend on the range of tolerable misregistration, the half-toning method chosen, ink colors, and ink-media interactions. Tilings useable for this purpose are discussed in U.S. Pat. No. 5,689,623, issued Nov. 18, 1997 and entitled SPREAD SPECTRUM DIGITAL SCREENING, which is herein incorporated by reference.

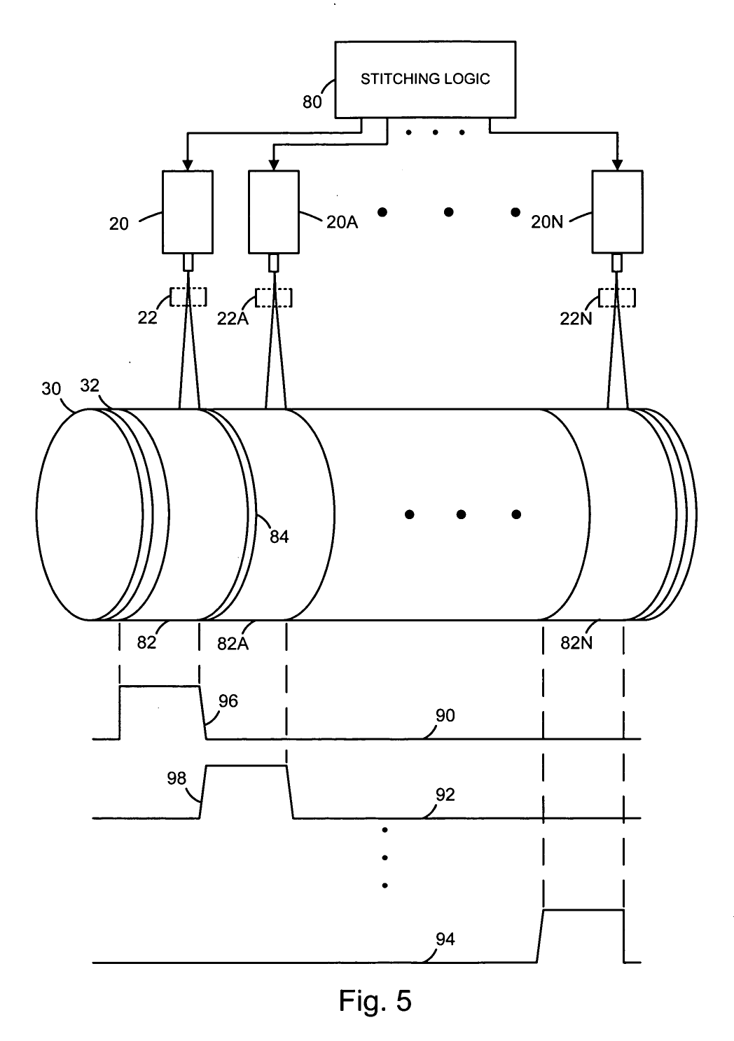

Stitching can also take place between further regions 82A . . . 82N, producing further overlap regions between them, and some of the swaths will therefore be stitched on both ends. This stitching approach can be applied to helical print progressions, cylindrical print progressions, or other types of swathed print progressions, and these progressions can also employ different types of interleaving. And while the stitching is shown for a simple single-revolution system with stationary heads, stitching according to the invention is also applicable to cases in which swaths are deposited with one or more moving heads that can move with respect of the substrate and/or deposit ink over several revolutions (see, e.g., FIG. 5). The substrate can be loaded on a drum, platen, or other type of feed mechanism.

Other types of print substrates can also be used, including three-dimensional substrates, such as plastic bottles. In one embodiment, a plastic bottle is rotated about its axis of rotation while a series of nozzles spaced along the length of the bottle deposit ink on the bottle in a single revolution of the bottle. This single-pass system can decorate a bottle very quickly, as required by large-scale manufacturing processes. Systems suitable for swathed printing on three-dimensional substrates are discussed in a copending application entitled JET PRINTER WITH ENHANCED PRINT DROP DELIVERY, filed on the same day as the present application and herein incorporated by reference. The subject matter of this application is also related to the disclosure of U.S. Pat. No. 6,626,527, filed on Oct. 12, 2000, and entitled INTERLEAVED PRINTING, which is herein incorporated by reference.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

1. A continuous ink jet printer, comprising:
a first ink jet printing nozzle,
a first deflection element located proximate an output trajectory of the first ink jet printing nozzle and operative to deflect the ink drops in a first pattern as they are deposited on a substrate by the first ink jet printing nozzle,
a second ink jet printing nozzle,
a second deflection element located proximate an output trajectory of the second ink jet printing nozzle and operative to deflect the ink drops in a second pattern as they are deposited on the substrate by the second ink jet printing nozzle, with the first and second patterns overlapping at least partially, and
stitching logic including density adjustment logic operative to adjust print density for the first and second ink jet printing nozzles in a region of the substrate that is within both the first and second patterns.

2. The continuous ink jet printer of claim 1 wherein the stitching logic is operative to define a pair of complementary linear density progressions.

3. The continuous ink jet printer of claim 1 wherein the stitching logic includes stochastic screening logic to randomize printing in the region of the substrate that is within the first and second patterns.

4. The continuous ink jet printer of claim 1 wherein the print substrate is a printing plate.

5. The continuous ink jet printer of claim 1 wherein the print substrate is a plastic bottle.

6. The continuous ink jet printer of claim 1 wherein the deflection element is one of a pair of deflection electrodes.

7. The continuous ink jet printer of claim 1 further including swathing logic to generate the first and second patterns as swathed patterns.

8. The continuous ink jet printer of claim 1 wherein the swathing logic includes a series of different firing order entries that define different deflection amounts for at least one of the deflection elements.

9. The continuous ink jet printer of claim 1 further including binary logic to generate the first and second patterns as binary patterns.

10. The continuous ink jet printer of claim 1 further including halftone screening logic and wherein the first and second ink jet printing nozzles are responsive to the halftone screening logic.

11. The continuous ink jet printer of claim 1 further including interleaving logic operative to cause the first and second ink jet printing nozzles to print simultaneously.

12. The continuous ink jet printer of claim 1 wherein the interleaving logic further includes self interleaving logic operative to cause at least one of the first and second ink jet printing nozzles to print in a series of self-interleaved passes.

13. The continuous ink jet printer of claim 1 wherein the stitching logic is operative to cause the first and second ink jet printing nozzles to print drops in the region during a same pass.

14. The continuous ink jet printer of claim 1 wherein the stitching logic is operative to cause the first and second ink jet printing nozzles to print drops in the region during a different pass.

15. The continuous ink jet printer of claim 1 further including a substrate feed mechanism to feed the substrate.

16. The continuous ink jet printer of claim 1 wherein the substrate feed mechanism includes a drum.

17. The continuous ink jet printer of claim 1 wherein the first and second ink jet printing nozzles are in a series of nozzles spaced along a direction of rotation of the substrate.

18. The continuous ink jet printer of claim 1 wherein the substrate feed mechanism includes a platen.

19. The continuous ink jet printer of claim 1 wherein the substrate feed mechanism is operative to cause printing to take place in a helical scan.

20. The continuous ink jet printer of claim 1 wherein the substrate feed mechanism is operative to cause printing to take place in a single pass between a) the substrate and b) the first and second nozzles.

21. The continuous ink jet printer of claim 1 wherein the substrate feed mechanism is operative to cause printing to take place in a multiple passes between a) the substrate and b) the first and second nozzles.

22. The continuous ink jet printer of claim 1 wherein the first and second ink jet printing nozzles are both positioned to print at pixel positions on a same grid having horizontal and vertical pitches equal to those of the first and second nozzles.

23. A continuous ink jet printing method, comprising:
firing a first stream of ink drops,
deflecting drops in the first stream to create a first deposition pattern,
firing a second stream of ink drops,
deflecting drops in the second stream to create a second deposition pattern that overlaps at least in part with the first deposition pattern, and
adjusting print density for drops corresponding to a region of overlap between the first and second deposition patterns.

24. The method of claim 23 wherein the steps of deflecting deflect swathed deposition patterns.

25. A continuous ink jet printer, comprising:
means for firing a first stream of ink drops,
means for deflecting drops in the first stream to create a first deposition pattern,
means for firing a second stream of ink drops,
means for deflecting drops in the second stream to create a second deposition pattern that overlaps at least in part with the first deposition pattern, and
means for adjusting print density for drops corresponding to a region of overlap between the first and second deposition patterns.

26. The apparatus of claim 25 wherein the means for deflecting deflect swathed deposition patterns.
